(19) United States
(12) Patent Application Publication
(10) Pub. No.: US 2016/0096317 A1
(43) Pub. Date: Apr. 7, 2016

(54) METHOD OF MAKING A MOLDED ARTICLE AND MOLDED ARTICLE

(71) Applicant: TAIWAN GREEN POINT ENTERPRISES CO., LTD., Taichung City (TW)

(72) Inventors: Shian-Yih WANG, Taichung City (TW); Hong-Jun CHEN, Taichung City (TW); Ying-Jen CHU, Taichung City (TW); Yung-Chih CHEN, Taichung City (TW); Jung-Feng HSIEH, Taichung City (TW)

(73) Assignee: TAIWAN GREEN POINT ENTERPRISES CO., LTD., Taichung City (TW)

(21) Appl. No.: 14/870,841

(22) Filed: Sep. 30, 2015

(30) Foreign Application Priority Data
Oct. 3, 2014 (TW) 103134605

(51) Int. Cl. B29C 65/70; B32B 3/08; B32B 3/26; B29C 53/04

(52) U.S. Cl. CPC B29C 65/70; B29C 53/04; B32B 3/08; B32B 3/263; B32B 3/266; B29K 2101/12

(57) ABSTRACT

A method of making a molded article includes the steps of providing a first sheet member and a second sheet member that are made of a fiber composite material and that are different in shape. The method further includes laminating the first and second sheet members into a main body that has a thick region and a thin region having a thickness smaller than that of the thick region and forming and bonding a molded body on the main body by a molding technique so as to obtain the molded article.

### CROSS-REFERENCE TO RELATED APPLICATION

This application claims priority of Taiwanese Patent Application No. 103134605, filed on Oct. 3, 2014.

### FIELD

Embodiments of the invention generally relate to a method of making a molded article and a molded article made therefrom, more particularly to a method of making a molded article using a fiber composite material and a molded article made therefrom.

### BACKGROUND

Portable electronic devices are generally designed to be thin and lightweight. However, there are other factors, such as structural strength, appearance, and so on, that need to be considered.

U.S. Patent Application Publication No. 2002/0106952 A1 discloses an injection molded article that may be used as an electronic device casing. The injection molded article includes a core member made of a fiber material, a resin surface layer and a structural member. The resin surface layer and the structural member are integrally molded by an injection molding technique. With the core member, the injection molded article has improved structural strength compared to an article made by resin injection molding, and has reduced manufacturing costs and reduced weight compared to an article made of metal.

The core member may be constituted by a prepreg that includes a reinforcing fiber material impregnated with a thermoplastic resin and that has a uniform thickness that can achieve a desired mechanical strength. The structural member is a molded body that is formed and bonded to the prepreg using a plastic injection molding technique. The molded body may be an engaging structural member for facilitating assembling of the casing to an electronic device.

It should be noted that the resin materials contained in the prepreg and the molded body should be compatible in property such that the molded body is able to be directly bonded to the prepreg by injection molding, thereby avoiding the use of an adhesive material.

The casing composed of the core member with the uniform thickness and the molded body formed on the core member usually has an undesirably excessive thickness. Therefore, a CNC lathe or laser is used to remove a part of the prepreg so as to form a thin region. The molded body is bonded to the thin region of the prepreg to obtain the casing with desirable overall mechanical strength and reduced thickness.

However, removal of the part of the prepreg would cause fracture of fibers in the reinforcing fiber material, resulting in decreased mechanical strength at the thin region. Moreover, the fractured fibers are exposed at the thin region of the prepreg and adversely affect the bonding strength between the molded body and the thin region of the prepreg.

Furthermore, during cooling in the injection molding process, the molded body with a large thickness may shrink excessively, causing sink marks on the casing.

### SUMMARY

In certain embodiments of the disclosure, a method of making a molded article may be provided. The method may include: providing a first sheet member and a second sheet member that are made of a fiber composite material and that are different in shape; laminating the first and second sheet members into a main body that has a thick region and a thin region having a thickness smaller than that of the thick region; and forming and bonding a molded body on the main body by a molding technique so as to obtain the molded article.

In certain embodiments of the disclosure, a molded article may be provided. The molded article may include: a main body that includes a first sheet member and a second sheet member laminated to the first sheet member, the first and second sheet members being made of a fiber composite material, and being different in shape, the main body having a thick region and a thin region that has a thickness smaller than that of the thick region; and a molded body that is formed by a molding technique and that is bonded to the main body.

In certain embodiments of the disclosure, a molded article may be provided. The molded article may include: a laminated main body that includes a plurality of sheet members made of a fiber composite material, the laminated main body having a thick region and a thin region that has a thickness smaller than that of the thick region; and a molded body that is bonded to the laminated main body. At least one side of the main body is bent to form a side wall, which is constituted by at least a part of the thin region. The molded body is bonded to at least the side wall of the main body.

### BRIEF DESCRIPTION OF THE DRAWINGS

Other features and advantages of the disclosure will become apparent in the following detailed description of the exemplary embodiments with reference to the accompanying drawings, of which:

FIG. 1 is a flow chart of a first embodiment of a method of making a molded article;

FIG. 2 is a schematic view of a first sheet member and a second sheet member used in the first embodiment;

FIG. 3 is a schematic view of a main body composed of the first sheet member and the second sheet member shown in FIG. 2;

FIG. 4 is a cross-sectional view of the main body taken along line IV-IV of FIG. 3;

FIG. 5 is a cross-sectional view of the main body taken along line V-V of FIG. 3;

FIG. 6 is a cross-sectional view of the main body that is bent into a desired shape;

FIG. 7 is a cross-sectional view of a molded article made by the method of FIG. 1;

FIG. 8 is a cross-sectional view of a main body produced during a second embodiment of a method of making a molded article;

FIG. 9 is a cross-sectional view of a molded article made by a third embodiment of a method of making the molded article;

FIG. 10 is a schematic view of a first sheet member and a second sheet member used in a fourth embodiment of a method of making a molded article;

FIG. 11 is a schematic view of a main body composed by the first sheet member and the second sheet member shown in FIG. 10;

FIG. 12 is a cross-sectional view of the main body taken along line XII-XII of FIG. 11; and

FIG. 13 is a cross-sectional view of the molded article made by the fourth embodiment.

### DETAILED DESCRIPTION OF THE EXEMPLARY EMBODIMENTS

It may be noted that like elements are denoted by the same reference numerals throughout the disclosure.

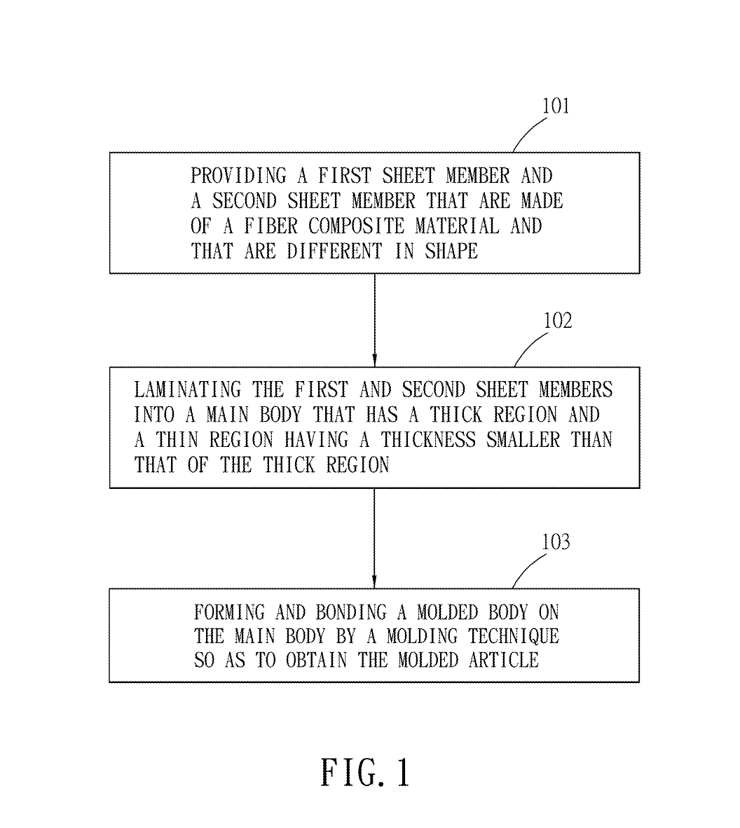

FIG. 1 illustrates a first embodiment of a method of making a molded article which includes the steps of:

Step 101 of providing a first sheet member 1 and a second sheet member 2 that are made of a fiber composite material and that are different in shape;

Step 102 of laminating the first and second sheet members 1, 2 into a main body 3 that has a thick region 301 and a thin region 302 having a thickness smaller than that of the thick region 301; and

Step 103 of forming and bonding a molded body 4 on the main body 3 by a molding technique so as to obtain the molded article.

The fiber composite material may be a commercially available fiber-reinforced plastic material. In certain embodiments, the fiber composite material is a fiber-reinforced thermoplastic material.

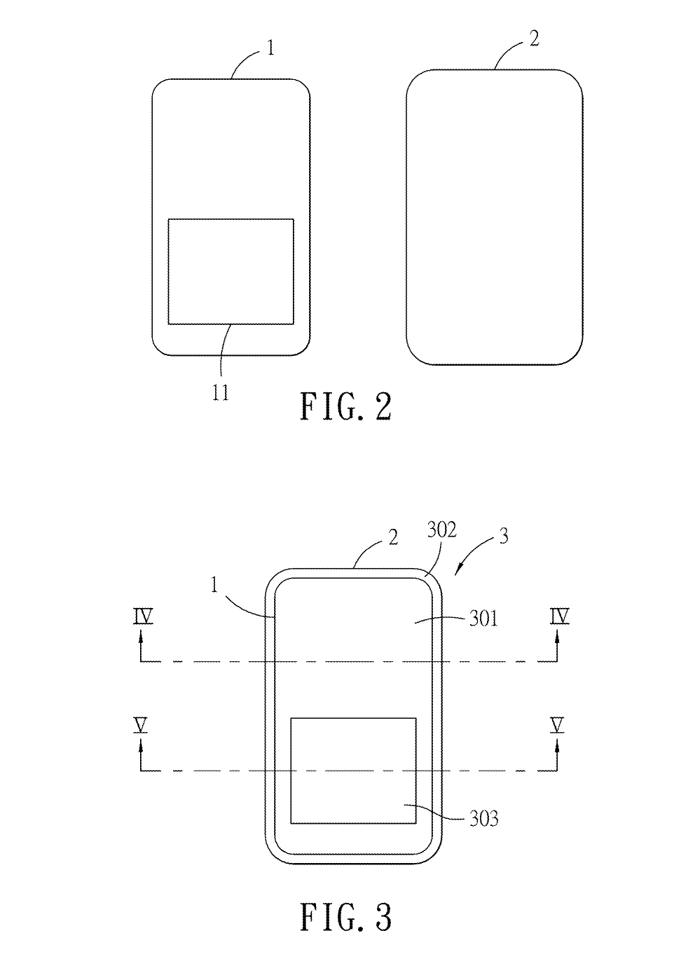

Referring to FIG. 2, in Step 101, the first and second sheet members 1, 2 respectively have contacting surfaces that contact with each other. The contacting surface of the first sheet member 1 has an area smaller than that of the second sheet member 2. In certain embodiments, the first sheet member 1 is formed with a hollow region 11, and the second sheet member 2 covers the hollow region 11 so that the main body 3 further has a recessed region 303 corresponding in position to the hollow region 11 of the first sheet member 1.

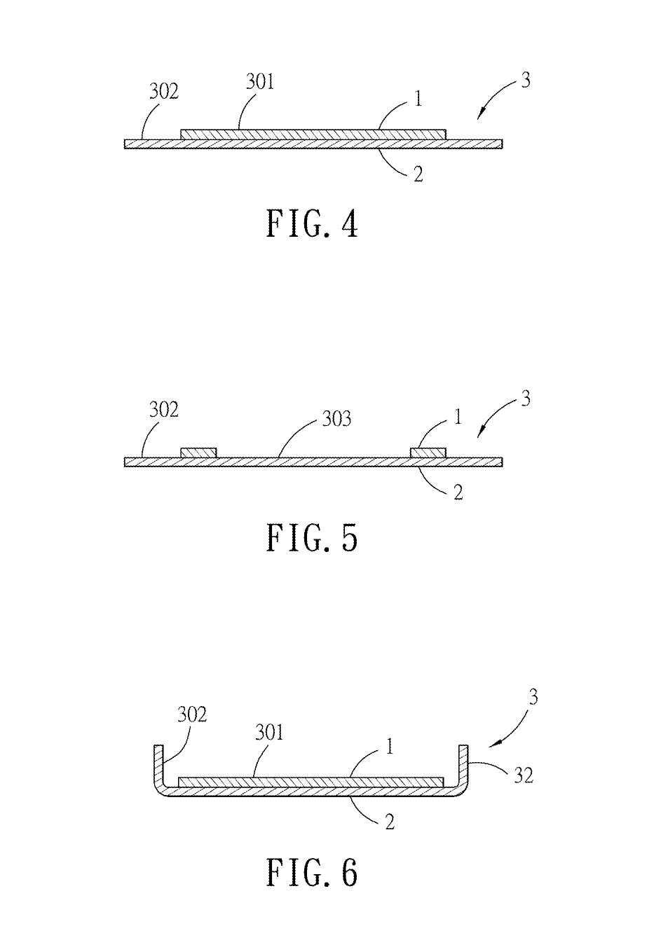

Referring to FIGS. 3 to 5, in Step 102, since the fiber composite material is the fiber-reinforced thermoplastic material, the first and second sheet members 1, 2 may be welded together. Referring particularly to FIGS. 4 and 5, the thick region 301 of the main body 3 is the region where the first and second sheet members 1, 2 overlap, and the thin region 302 is the region constituted by a part of the second sheet member 2 that does not overlap the first sheet member 1. In certain embodiments, the thin region 302 surrounds the thick region 301 and the recessed region 303 is located at the thick region 301.

Referring to FIG. 6, in certain embodiments, the method of making the molded article may further include, before Step 103, a step of bending the main body 3 into a desired shaped. In one embodiment, at least one side of the main body 3 is bent to form a side wall 32. The side wall 32 is constituted by at least a part of the thin region 302 and being bonded to the molded body 4. The bending step may be conducted by placing the main body 3 in a first mold (not shown) and molding the same into the desired shape (e.g., forming the side wall 32). The molded article may be an electronic device casing.

In certain embodiments, the laminating step (i.e., Step 102) and the bending step are simultaneously conducted in a single mold. To be specific, the first and second sheet members 1, 2 are placed into the first mold and are aligned with each other by a position mechanism of the first mold. Then, the first and second sheet members 1, 2 are laminated and shaped in the first mold by heat and pressure to form the main body 3 with a desired shape.

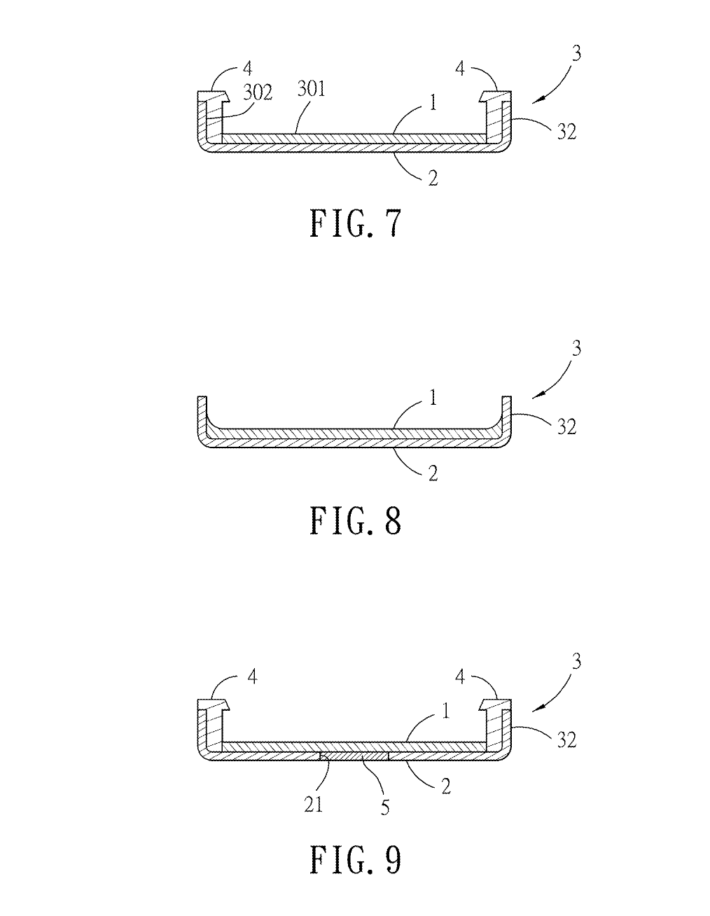

Referring to FIG. 7, in Step 103, the main body 3 with the desired shape is placed into a second mold (not shown) for forming and bonding the molded body 4 to the main body 3 in the second mold. The molded body 4 may be bonded to the thin region 302 of the main body 3. The molded body 4 may be made of a plastic material that is compatible in property with the fiber composite material so that the molded body 4 is able to directly bond to the main body 3, thereby avoiding the use of an adhesive material. In certain embodiments, the molded body 4 may be an engaging member, and may be formed at the thin region 302 by an insert molding technique. Note that the configuration of the molded body 4 may be altered according to practical requirements. The thin region 302 of the main body 3 provides sufficient space for the formation of the molded body 4. Therefore, the molded body 4 can be formed with ample thickness to achieve a desired mechanical strength. In certain embodiments, the molded body 4 may be bonded to the recessed region 303 of the main body 3.

By using the first sheet member 1 and the second sheet member 2 that are different in shape to form the main body 3 having the thin region 302, a step of removing a part of the main body 3 can be omitted, thereby avoiding fracturing the continuous fibers in the main body 3 and adversely affecting the bonding strength between the molded body 4 and the main body 3. It should be noted that the main body 3 may be made by laminating more than two sheet members together.

The disclosure also provides a second embodiment of a method of making a molded article. The second embodiment is similar to the first embodiment except that, in the bending step of the second embodiment, a peripheral portion of the first sheet member 1 may also be subjected to a desired pressure and temperature, so that the first sheet member 1 has a thickness gradually decreasing toward a periphery of the first sheet member 1, and a junction between the periphery of the first sheet member 1 and the second sheet member 2 is smoothed out (see FIG. 8), thereby facilitating mold release in the first and second molds. In the bending step, the first and second sheet members 1, 2 may be pressed at desired positions according to practical requirements.

The disclosure also provides a third embodiment of a method of making a molded article. The third embodiment is similar to the first embodiment except that, in the third embodiment, the second sheet member 2 is formed with a hollow region 21 and the first sheet member 1 covers the hollow region 21 of the second sheet member 2. In certain embodiments, the method further includes a step of forming a decoration 5 in the hollow region 21 of the second sheet member 2 (see FIG. 9). It should be noted that the second sheet member 2 may be formed with a plurality of the hollow regions 21 to form a desired pattern. Alternatively, the hollow region 21 can be configured to have a desired shape, such as a trademarked logo. The decoration 5 may be made of metal or colored materials for improving appearance of the molded article.

Alternatively, the decoration 5 may be formed by digital printing, deposition, in-mold decoration, painting, etc.

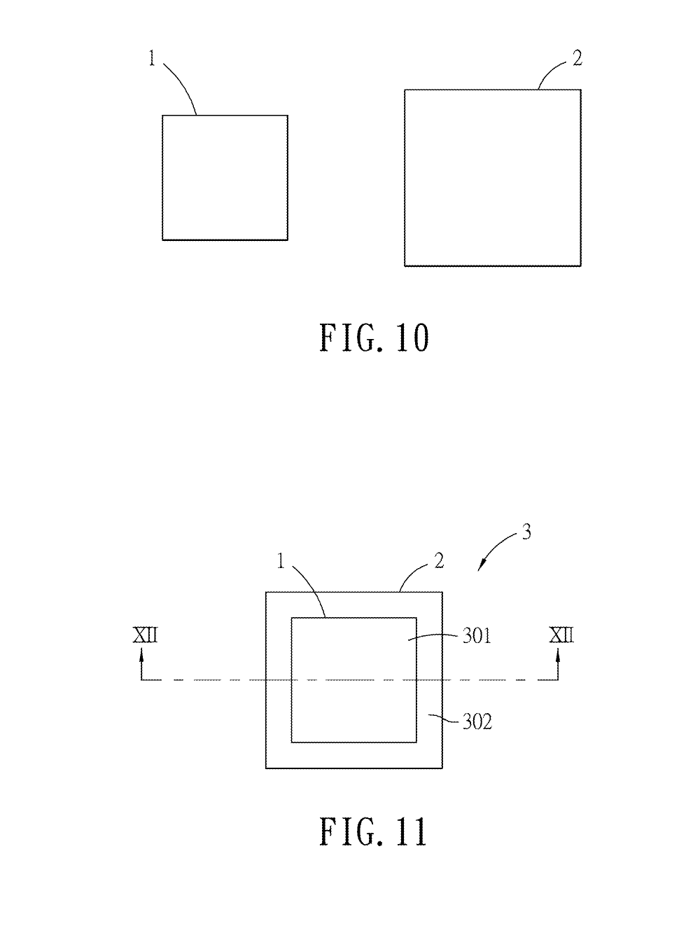

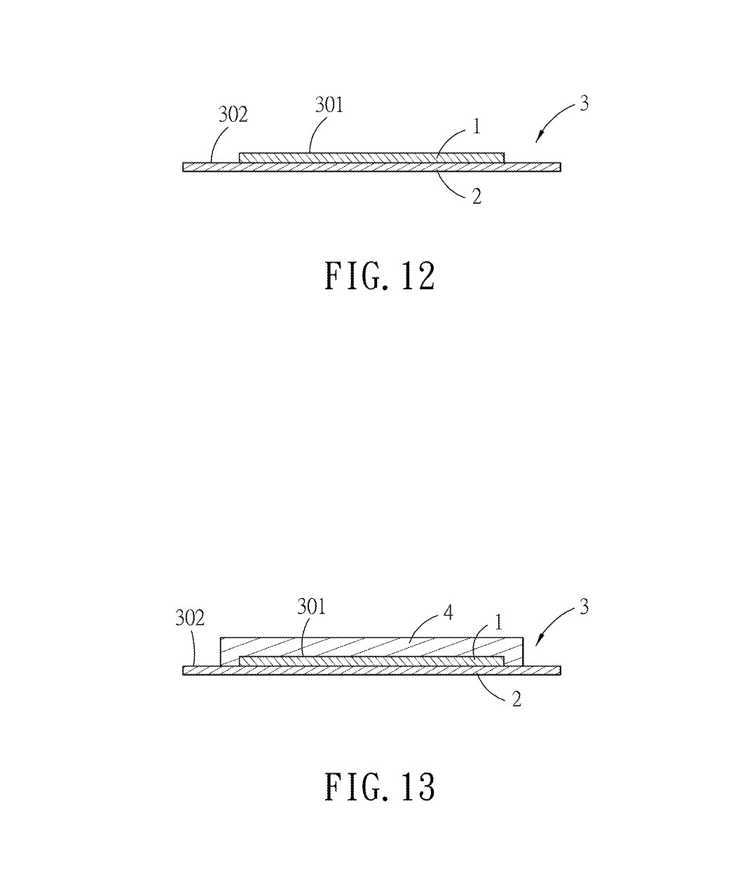

FIGS. 10 to 13 illustrate a fourth embodiment of a method of making a molded article. The method includes the steps of providing a first sheet member 1 and a second sheet member 2 that are made of a fiber composite material and that are different in shape (see FIG. 10, similar to Step 101), followed by laminating (e.g., welding) the first and second sheet members 1, 2 into a main body 3 (similar to Step 102). As shown in FIGS. 11 and 12, the main body 3 has a thick region 301 where the first and second sheet members 1,2 overlap, and a thin region 302 that is constituted by a part of the second sheet member 2 that does not overlap the first sheet member 1, and that has a thickness smaller than that of the thick region 301. Similar to Step 103, the main body 3 is then placed into a mold (not shown), and a molded body 4 is formed and bonded to the thick region 301 of the main body 3 in the mold. In certain embodiments, the first and second sheet members 1, 2 may be laminated together in the mold used in forming and bonding the molded body 4 to the main body 3 (i.e., the laminating step and the forming and bonding step are conducted in the same mold). With the molded body 4 being bonded to the thick region 301 of the main body 3, the thickness of the molded body 4 may be reduced, thereby alleviating the formation of the sink marks during cooling of the molded body 4 in the step of forming and bonding the molded body 4.

It should be particularly pointed out that the numbers and the locations of the thick region 301 and the thin region 302 of the main body 3, and the molded body 4 may be altered according to practical requirements.

To sum up, with the first and second sheet members 1, 2 being different in shape, the main body 3 is formed with the thin region 302 without having to cut the main body 3, thereby avoiding fracturing the continuous fibers in the main body 3, and improving the bonding strength between the main body 3 and the molded body 4. Moreover, the molded body 4 may be bonded to the thick region 301 of the main body 3 so that the thickness of the molded body 4 is reduced, thereby alleviating the formation of the sink marks in the molded article.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method of making a molded article, comprising the steps of:
providing a first sheet member and a second sheet member that are made of a fiber composite material and that are different in shape;
laminating the first and second sheet members into a main body that has a thick region and a thin region having a thickness smaller than that of the thick region; and
forming and bonding a molded body on the main body by a molding technique so as to obtain the molded article.

2. The method of claim 1, wherein:
in the providing step, one of the first and second sheet members is formed with a hollow region; and
in the laminating step, the other of the first and second sheet members covers the hollow region of the one of the first and second sheet members.

3. The method of claim 2, further comprising a step of forming a decoration in the hollow region of the one of the first and second sheet members.

4. The method of claim 1, wherein the molded body is bonded to at least the thin region of the main body.

5. The method of claim 4, further comprising, before the forming and bonding step, a step of bending at least one side of the main body to form a side wall, the side wall being constituted by at least a part of the thin region and being bonded to the molded body.

6. The method of claim 1, wherein, after the laminating step, the main body is placed into a first mold and molded into a desired shape, followed by placing the main body into a second mold, and forming and bonding the molded body to the main body in the second mold.

7. The method of claim 6, wherein:
the first and second sheet members respectively have contacting surfaces that contact with each other, the contacting surface of the first sheet member having an area smaller than that of the second sheet member; and
in the first mold, a peripheral portion of the first sheet member is pressed such that the first sheet member has a thickness gradually decreasing toward a periphery of the first sheet member.

8. The method of claim 1, wherein, in the laminating step, the first and second sheet members are laminated in a first mold to form the main body with a desired shape, followed by placing the main body into a second mold, and forming and bonding the molded body to the main body.

9. The method of claim 8, wherein:
the first and second sheet members respectively have contacting surfaces that contact with each other, the contacting surface of the first sheet member having an area smaller than that of the second sheet member; and
in the first mold, a peripheral portion of the first sheet member is pressed such that the first sheet member has a thickness gradually decreasing toward a periphery of the first sheet member.

10. The method of claim 1, wherein the molded body is bonded to at least the thick region of the main body.

11. The method of claim 1, wherein the laminating step and the forming and bonding step are conducted in the same mold.

12. A molded article comprising:
a main body that includes a first sheet member and a second sheet member laminated to said first sheet member, said first and second sheet members being made of a fiber composite material, and being different in shape, said main body having a thick region and a thin region that has a thickness smaller than that of said thick region; and
a molded body that is formed by a molding technique and that is bonded to said main body.

13. The molded article as claimed in claim 12, wherein one of said first and second sheet members is formed with a hollow region, the other one of said first and second sheet members covering said hollow region of said one of said first and second sheet members to form said main body.

14. The molded article as claimed in claim 13, further comprising a decoration formed in said hollow region of said one of said first and second sheet members.

15. The molded article as claimed in claim 12, wherein said molded body is bonded to at least said thin region of said main body.

16. The molded article as claimed in claim 12, wherein said molded body is bonded to at least said thick region of said main body.

17. The molded article as claimed in claim 12, wherein at least one side of said main body is bent to form a side wall, said side wall being constituted by at least a part of said thin region and being bonded to said molded body.

18. The molded article as claimed in claim 12, wherein said molded body is an engaging member.

19. The molded article as claimed in claim 12, wherein said first and second sheet members respectively have contacting surfaces that contact with each other, the contacting surface of said first sheet member having an area smaller than that of said second sheet member, said first sheet member having a thickness gradually decreasing toward a periphery thereof.

20. A molded article comprising:
a laminated main body that includes a plurality of sheet members made of a fiber composite material, said laminated main body having a thick region and a thin region that has a thickness smaller than that of said thick region; and
a molded body that is bonded to said laminated main body,
wherein at least one side of said laminated main body is bent to form a side wall, said side wall being constituted by at least a part of said thin region, said molded body being bonded to at least said side wall of said laminated main body.
